(19) United States
(12) Patent Application Publication
(10) Pub. No.: US 2013/0057561 A1
(43) Pub. Date: Mar. 7, 2013

(54) SYSTEM AND METHOD FOR RENDERING GRAPHICS CONTENT ASSOCIATED WITH AN APPLICATION PROCESS TO A DISPLAY AREA MANAGED BY ANOTHER PROCESS

(71) Applicants: Itay Nave, Kfar Hess (IL); Haggai David, Petach-Tikva (IL)

(72) Inventors: Itay Nave, Kfar Hess (IL); Haggai David, Petach-Tikva (IL)

(73) Assignee: EXENT TECHNOLOGIES, LTD., Petach-Tikva (IL)

(21) Appl. No.: 13/227,296

(22) Filed: Sep. 7, 2011

(51) Int. Cl. G06T 1/00

(52) U.S. Cl. 345/522

(57) ABSTRACT

A system and method for displaying graphics content associated with a software application process executing on a computing device in a display area managed by another process executing on the computing device are described. The system includes a processing unit and a memory. The memory contains instructions, which, when executed by the processing unit, cause the graphics content associated with the software application process being executed by the processing unit to be displayed within a display area managed by another process being executed by the processing unit by performing a number of steps. The steps include intercepting one or more function calls issued from the software application process. The steps also include capturing an image stored in a first portion of memory in response to intercepting the one or more function calls. The steps further include displaying the captured image in the display area managed by the other process.

### BACKGROUND OF THE INVENTION

1. Field of the Invention

The present invention generally relates to software applications that are configured to render graphics content to a display. In particular, the present invention relates to a system and method for rendering graphics content associated with an application, such as a video game application, executing on a computing device to a display area managed by another process on the computing device.

2. Background

As the World Wide Web evolves, users are becoming more and more accustomed to playing games embedded in a display window of a Web browser. For example, top online services, such as Facebook® and other portals, allow users to play, communicate, and share information all within the context of the same Web browser display window without having to open any application in a full screen display mode. Furthermore, newer platforms, such as the Google Chrome™ operating system (OS), require all application content to be displayed solely within a Web browser display window. As such, there is no way to open an application in a full screen display mode using such a platform.

To introduce games into a Web environment, game developers use several technologies. One commonly-used technology is Adobe Flash®. Flash® plug-ins are installed on most operating systems, thereby allowing game developers to develop games that are executed within the context of the Web browser. Still other plug-ins are available for developing games that can be executed within the context of a Web browser. In addition to plug-ins, other technologies that can be used by game developers to write games that execute within the context of a Web browser include HTML5 and WebGL. HTML5 is the fifth revision of the HTML standard and is a language for structuring and presenting content via the Web. WebGL is a software library that extends the capability of the JavaScript programming language to allow it to generate interactive 3D graphics within any compatible Web browser.

Although Web-browser based gaming is becoming increasingly popular, many existing games have been designed to run in a standalone mode outside of a Web browser. For example, many existing games designed for personal computers (PCs) or video game consoles have been designed to run in a full screen display mode outside of the context of a Web browser. It may be deemed desirable to make such games accessible from within the context of a Web browser. One way to address this issue would be to port or translate such standalone applications into applications that could be executed on a Web-based platform. However, this generally requires a manual porting process for each desired platform. This process is difficult and time consuming. As such, the manual process is not efficient with the rapid development pace of new platforms and capabilities of the Web.

### BRIEF SUMMARY OF THE INVENTION

Various approaches are described herein for, among other things, displaying graphics content associated with a software application process, such as a video game application process, executing on a computing device in a display area managed by another process executing on the computing device, even though the software application was not originally programmed to support such functionality. In one embodiment of the present invention, implementing this enhancement does not require modifying and recompiling the original source code of the software application.

For example, a method for displaying graphics content associated with a software application process executing on a computing device in a display area managed by another process executing on the computing device is described herein. In accordance with the method one or more function calls issued from the software application process executing on the computing device are intercepted. Responsive to the interception, an image stored in a first portion of memory is captured. The captured image is then displayed in the display area managed by the other process.

A computer program product is also described herein. The computer program product comprises a computer-readable storage medium having computer program logic recorded thereon for enabling a processing unit to display graphics content associated with a software application process executing on a computing device in a display area managed by another process executing on the computing device. The computer program logic comprises first means, second means, and third means. The first means enables the processing unit to intercept one or more function calls issued from the software application process executing on the computing device. The second means enables the processing unit to capture an image stored in a first portion of memory in response to intercepting the one or more function calls. The third means enables the processing unit to display the captured image in the display area managed by the other process.

A system is further provided. The system includes a processing unit and a memory. The memory contains instructions, which, when executed by the processing unit, cause graphics content associated with a software application process being executed by the processing unit to be displayed within a display area managed by another process being executed by the processing unit by performing a number of steps. The steps include intercepting one or more function calls issued from the software application process. The steps also include capturing an image stored in a first portion of memory in response to intercepting the one or more function calls. The steps further include displaying the captured image in the display area managed by the other process.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 depicts components of a computer system in accordance with one embodiment of the present invention.

FIG. 2 illustrates a conventional software architecture for a personal computer (PC) that includes graphics commands for rendering and displaying graphics content.

FIG. 3 illustrates software architecture of a PC that includes emulated version of graphics functions for rending and displaying graphics content.

FIG. 4 depicts a flowchart of a method for rendering graphics content associated with a software application to a display area managed by a browser in accordance with an embodiment of the present invention.

FIG. 5 depicts a flowchart of a method for hiding an application window that displays graphics content associated with a software application in accordance with an embodiment of the present invention.

FIG. 6 depicts a flowchart of another method for hiding an application window that displays graphics content associated with a software application in accordance with an embodiment of the present invention.

FIG. 7 depicts a flowchart of a method for indicating that an application window associated with a software application is active in accordance with an embodiment of the present invention.

FIG. 8 depicts a flowchart of a method for resizing the application window that displays graphics content associated with the software application in accordance with an embodiment of the present invention.

FIG. 9 depicts a flowchart for capturing image data generated by a software application process and transferring the image data to another process in accordance with an embodiment of the present invention.

FIG. 10 depicts an example display area managed by a Web browser to which graphics content has been rendered in accordance with an embodiment of the present invention.

FIG. 11 depicts a flowchart of a method for repositioning a pointer image within a display area managed by a Web browser to account for the resizing of application-related graphics content in accordance with an embodiment of the present invention.

FIG. 12 depicts an exemplary computer system that may be used to implement an embodiment of the present invention.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Various approaches are described herein for, among other things, displaying graphics content associated with a software application process, such as a video game application process, executing on a computing device in a display area managed by another process executing on the computing device, even though the software application was not originally programmed to support such functionality. In one embodiment of the present invention, implementing this enhancement does not require modifying and recompiling the original source code of the software application.

In one embodiment, the display area that is managed by the other process executing on the computing device is a display area managed by a Web browser. The display area managed by the Web browser may comprise a windowed display area within a Web page as opposed to a full-screen display area normally used by the software application process. Thus, in accordance with such an embodiment, a user can play a video game (or execute some other application) that was originally designed for display in an application window associated with the video game within the windowed display area of a Web page, while also interacting with additional content of the Web page displayed by the browser. For example, if the user is playing the video game in the windowed display area of a social-networking Web page, the user is also able to remain connected to his social network while playing the video game.

### II. Example Components of a System in Accordance with an Embodiment of the Present Invention

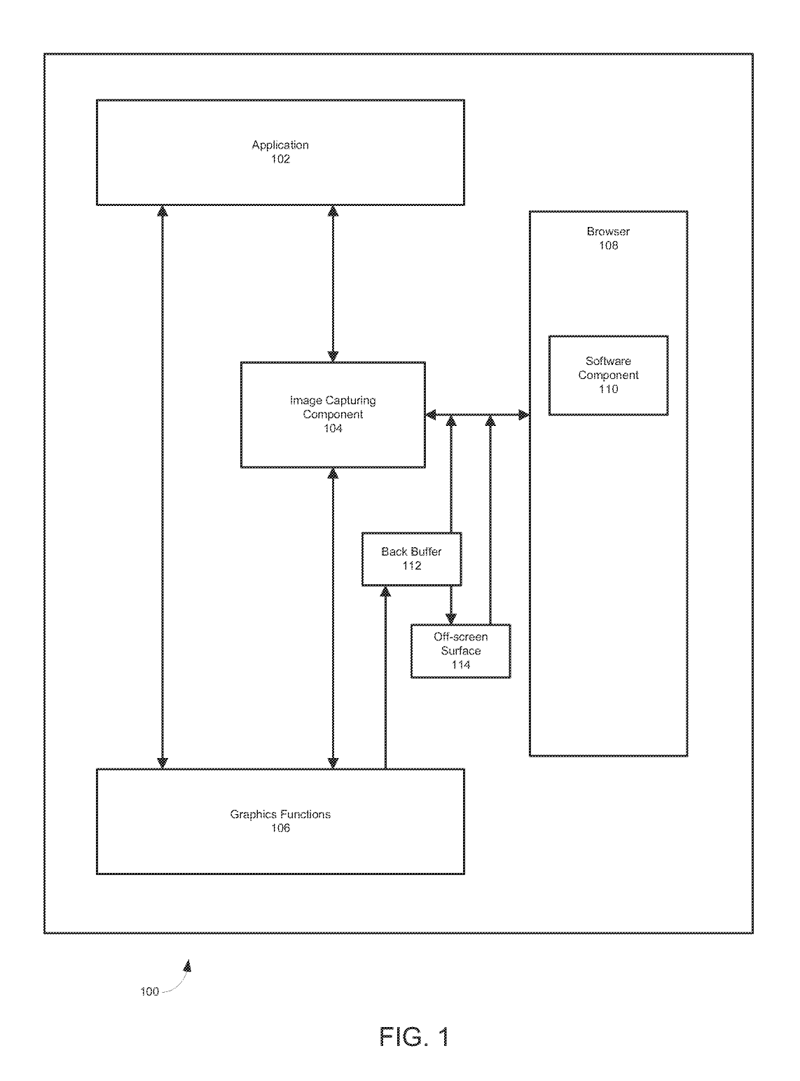

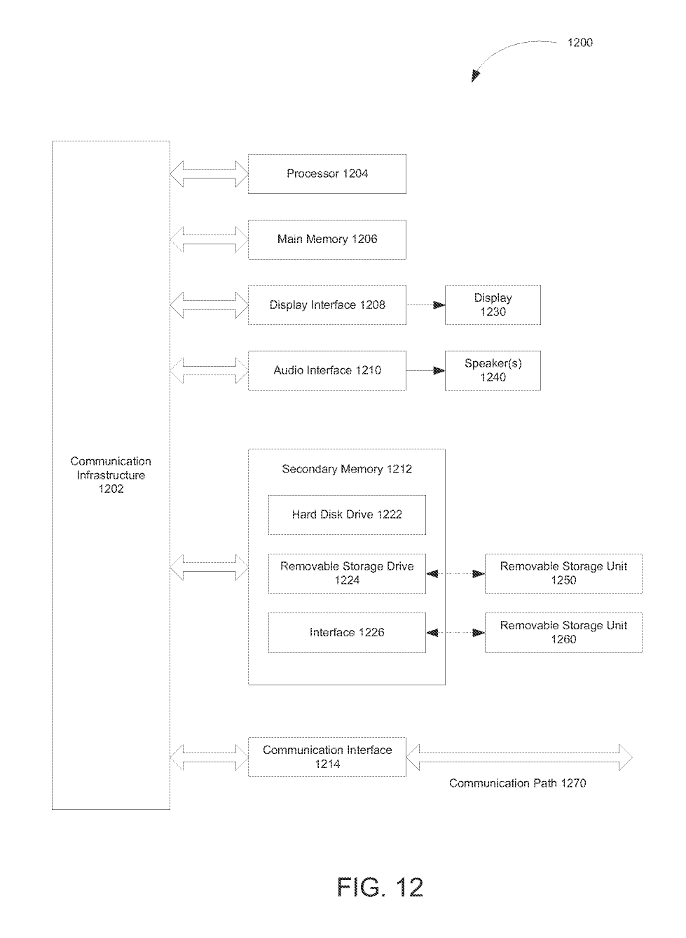

FIG. 1 depicts components of a computer system 100 in accordance with one embodiment of the present invention that displays graphics content associated with a software application process executing thereon in a display area managed by another process executing thereon, even though the software application was not originally programmed to support such functionality. As shown in FIG. 1, system 100 includes an application 102, an image capturing component 104, graphics functions 106, a back buffer 112, an off-screen surface 112, and a browser 108. It is to be understood that each of these components is stored in memory within or accessible by computer system 100 and is configured to be executed and/or utilized by hardware components of computer system 100. Example hardware components of computer system 100 are described in detail below in reference to FIG. 12.

Application 102 is a software application, such as a video game application, that is designed to generate graphics content for display in an application window associated with the application 102. Application 102 may be configured to display the graphics content in the application window using either a full-screen mode or a windowed mode. Application 102 is executed by computer system 100 and may be one of many processes executed by computer system 100. Graphics functions 106 are software functions of computer system 100 that are accessible to application 102 during run-time and provide the interface for application 102 for rendering application-related graphics information to a display within computer system 100. Graphics functions 106 may comprise, for example, one or more functions of an application programming interface (API) such as Microsoft® DirectX®, Microsoft® Direct3D® or OpenGL®. Image capturing component 104 is a software component that is installed on computer system 100 prior to execution of application 102. Image capturing component 104 may be installed on computer system 100 together with application 102, or independent of it.

Application 102 is programmed such that, during execution, it issues function calls to graphics functions 106. The interaction of application 102 with graphics functions 106 is well-known in the art. However, in accordance with an embodiment of the present invention, certain function calls issued by application 102 are intercepted by image capturing component 104. In response to intercepting these function calls, image capturing component 104 issues modified versions of the intercepted function calls and/or new function calls to graphics functions 106

Browser 108 is a software application that is configured to retrieve, present, and traverse network-accessible content, such as content made available via the World Wide Web. Browser 108 is executed by computer system 100. As such, browser 108 may also be one of many processes executed by computer system 100. Some well-known Web browsers include Internet Explorer®, (published by Microsoft Corporation of Redmond, Wash., Firefox®, (published by Mozilla Corporation of Mountain View, Calif.) and Chrome™ (published by Google Inc. of Mountain View, Calif.). As shown in FIG. 1, browser 108 may also include software component 110 that is configured to add certain abilities to browser 108. The design of software component 110 may vary depending on which browser is used to implement browser 108. For example, when browser 108 is implemented using Internet Explorer®, software component 110 may comprise an ActiveX plug-in. When using other browsers, such as Firefox® or Chrome®, software component 110 may comprise other plug-ins. It is noted that embodiments of the present invention may also be implemented using software component 110 in other software applications, such as, but not limited to e-mail clients, presentation applications, etc.

In certain embodiments, software component 110 may comprise a widget implemented using an ActiveX plug-in or other plug-in. A widget, as referred to herein, is a software application that can be installed and executed within a web page viewable by browser 108. Widgets may also be known as “modules,” “gadgets,” “capsules,” snippets,” “minis,” “flakes,” or “badges.” Widgets allow a website developer to enhance a website by embedding content or tools from one website onto a page of another website.

In one embodiment, software component 110 may be configured for displaying graphics content associated with application 102 executing on computer system 100. The graphics content is associated with application 102 in that it is generated by a process that is created when application 102 is executed on computer system 100. For example, a user may visit a Web page having software component 110 contained therein. The Web page is viewable using browser 108. Upon visiting the Web page, the user may be prompted to download application 102 onto computer system 100. Once downloaded, application 102 may be executed by computer system 100. However, instead of displaying graphics content associated with application 102 in an application window associated with application 102, the graphics content may be displayed in a windowed display area associated with software component 110. This advantageously enables the user to view and/or interact with graphics content associated with application 102 that is displayed on the Web page via browser 108, as well as view and/or interact with additional content of the Web page displayed in browser 108.

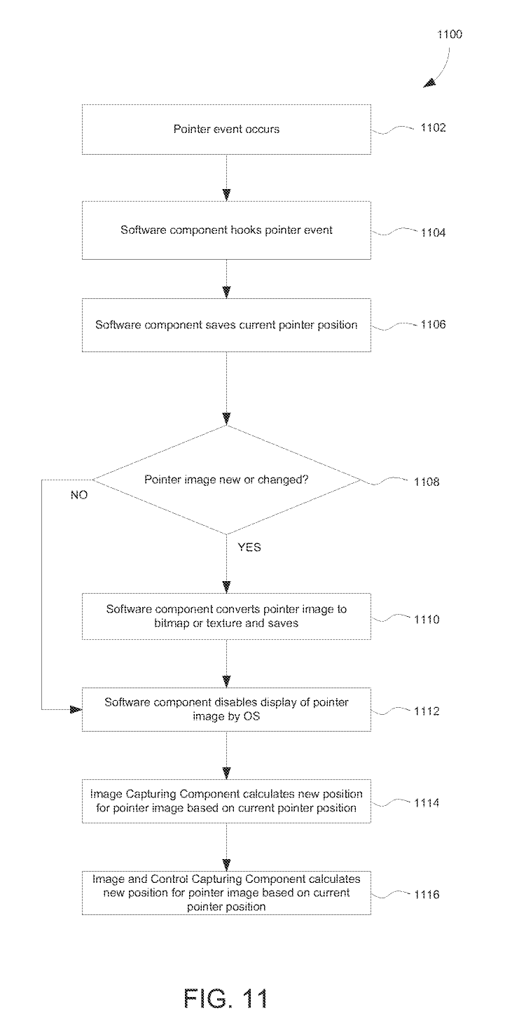

Additionally, software component 110 also captures control events that arise when the user interacts with the graphics content being displayed in the windowed display area associated with software component 110. Such control events may comprise user input events generated using a mouse, keyboard, joystick, gamepad, or any other input device known in the art. Once control events are captured, they are transferred to application 102. However, because application 102 is designed to generate graphics content using a different window size and/or resolution, certain control events may require translation before being transferred to application 102. For example, if the control event involves movement of a pointer image, the input/output (I/O) data associated with the control event should be translated in order to take into account a difference in resolution between an original resolution associated with application 102 and the resolution of the display area managed by browser 108. Once the control event is translated, the control event is transferred to application 102. Further information concerning the manner in which control events are captured and translated will be provided herein in reference to FIG. 11.

With continued reference to FIG. 1, image capturing component 104 is configured to intercept one or more graphics commands that are issued by application 102 to cause application-related graphics content to be rendered to the display area managed by browser 108 rather than to an application window associated with application 102. As previously mentioned, browser 108 includes software component 110, which may be a widget embedded in a web page viewable by browser 108. As such, the application-related graphics content may be rendered to a display area associated with the widget.

As will be discussed in more detail herein, in order to display graphics content associated with application 102, image capturing component 104 transfers image data generated by application 102 to software component 110 for rendering. In one embodiment, such image data may be stored in a portion of memory, for example back buffer 112. Back buffer 112 is well known to persons skilled in the relevant art(s), and thus is not described in detail herein for purposes of brevity. In one embodiment, image capturing component 104 locks back buffer 110 to prevent other processes (e.g., application 102) from accessing back buffer 112, resizes the image data to match the display area managed by browser 108, and transfers the image data to software component 110 for rendering. Thereafter, image capturing component 104 releases back buffer 112, which enables application 102 to continue to execute.

In another embodiment, image capturing component 104 copies the image data from back buffer 112 to another portion of memory, such as off-screen surface 114. Image capturing component 104 may copy the image to off-screen surface 114 by using a method of inter-process communication (IPC) such as Shared Memory. As will be appreciated by persons skilled in the relevant art(s), Shared Memory is an efficient means of passing data between two or more processes via IPC. Off-screen surface 114 may be a region of memory that is used exclusively by software component 110. By providing a dedicated region of memory for software component 110, software component 110 is allowed to manipulate the image data as necessary without having to lock back buffer 112. This advantageously allows application 102 to continue to execute while image capturing component 104 resizes the image data and transfers the image data to software component 110 for rendering, thereby preventing any unwanted delay in execution of application 102.

Image capturing component 104 may also be configured to receive control events captured by software component 110 and to forward the control events to application 102. In some instances, image capturing component 104 may translate certain control events before transferring the control events to application 108. For example, as previously mentioned, if the control event involves movement of a pointer image, the control event should be translated in order to take into account a difference in resolution between an original resolution associated with application 102 and a resolution of the display area managed by browser 108.

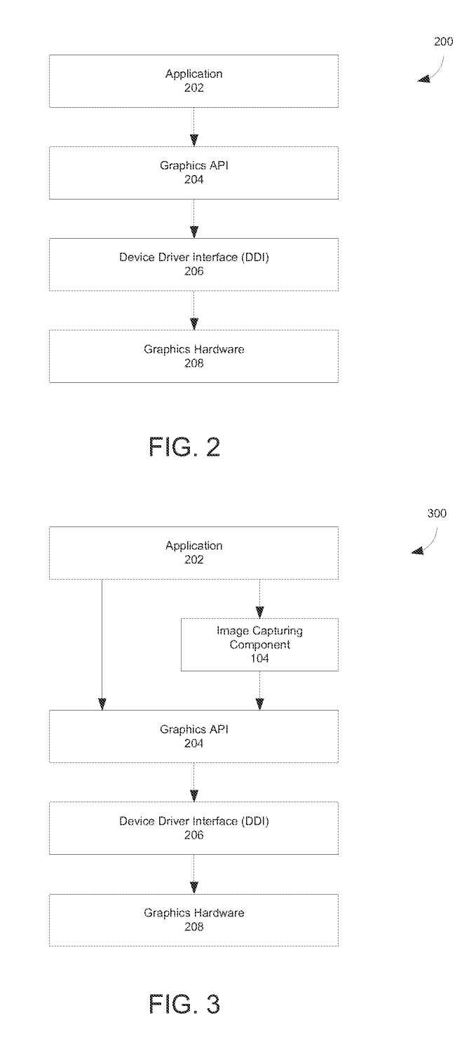

In one implementation of the present invention, in order to facilitate interception of function calls, image capturing component 104 comprises one or more emulated versions of certain graphics functions 106. A particular example of the emulation of graphics functions 206 will now be described with reference to FIGS. 2 and 3.

FIG. 2 illustrates a conventional software architecture 200 for a personal computer (PC). As shown in FIG. 2, software architecture 200 includes an application 202 executing on the PC. The PC may be, for example, a Microsoft® Windows®-based PC, and the application may be, for example, a 32-bit Microsoft® Windows® application. Although, it is noted that the techniques described herein are not limited to Windows®-based PC's. For example, application 202 may be executed on any appropriate computer system running any appropriate operating system, such as Mac® OS, UNIX®, or any of the many Linux®-based operating systems.

During execution, application 202 issues function calls to a graphics API 204 in a well-known manner Graphics API 204 comprises a series of libraries that are accessible to application 202 in PC memory and that include functions that may be called by application 202 for rendering and displaying graphics information. Graphics API 204 may be, for example, a Microsoft® Direct3D® API or an OpenGL® API. In response to receiving the function calls from application 202, graphics API 204 determines if such functions can be executed by graphics hardware 208 within the PC. If so, graphics API 204 issues commands to a device driver interface (DDI) 206 for graphics hardware 208. DDI 206 then processes the commands for handling by the graphics hardware 208.

In contrast to the conventional software architecture illustrated in FIG. 2, FIG. 3 illustrates a software architecture 300 that includes emulated graphics libraries in accordance with an embodiment of the present invention. As shown in FIG. 3, image capturing component 104 has been “inserted” between application 202 and graphics API 204. This may be achieved by emulating one or more graphics libraries within graphics API 204. As a result, certain function calls issued by application 202 are received by image capturing component 104 rather than graphics API 204. Image capturing component 104 then issues modified versions of the intercepted function calls and/or new function calls to graphics API 204, where they are handled in a conventional manner.

Depending on the operating system, emulating a genuine graphics API can be achieved in various ways. One method for emulating a genuine graphics API is file replacement. For example, since both DirectX® and OpenGL® APIs are dynamically loaded from a file, emulation can be achieved by simply replacing the pertinent file (for example, OpenGL.dll for OpenGL® and d3dX.dll for DirectX® where X is the DirectX® version). Alternatively, the DLL can be replaced with a stub DLL having a similar interface that implements a pass-through call to the original DLL for all functions but the functions to be intercepted.

An alternative method for intercepting function calls to the graphics API is to use the Detours hooking library published by Microsoft® Corporation of Redmond, Wash. Hooking may also be implemented at the kernel level. Kernel-level hooking may include the use of an operating system (OS) ready hook that generates a notification when a particular API is called. Another technique is to replace existing OS routines by changing a pointer in an OS API table to a hook routine pointer, and optionally chaining the call to the original OS routine before and/or after the hook logic execution. Another possible method is an API-based hooking technique that injects a DLL into any process that is being loaded by setting a global system hook or by setting a registry key to load such a DLL. Such injection is performed only to have the hook function running in the address space. While the OS loads such a DLL, a DLL initialization code changes a desired DLL dispatch table. Changing the table causes a pointer to the original API implementation to point to the interception DLL implementation for a desired API, thus hooking the API. Note that the above-describing hooking techniques are presented by way of example and are not intended to limit the present invention. Other methods and tools for intercepting function calls to graphics APIs are known to persons skilled in the relevant art(s).

### III. Example Methods for Rendering Graphics Content Associated with a Software Application Process to a Display Area Managed by Another Process

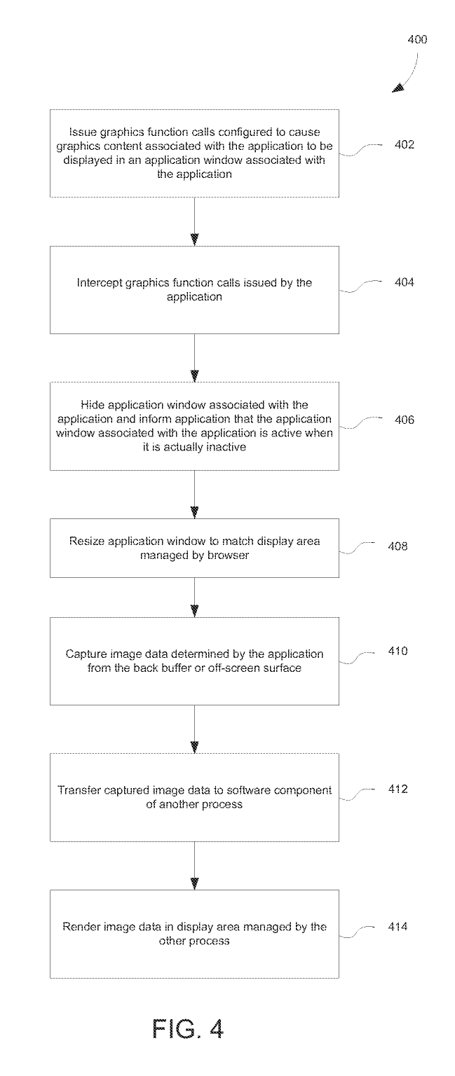

FIG. 4 depicts a flowchart 400 of a method for rendering graphics content associated with an executing software application process to a display area managed by another process in accordance with an embodiment of the present invention. The method of flowchart 400 is described herein by way of example only and is not intended to limit the present invention. Furthermore, although the steps of flowchart 400 will be described herein with reference to the components of system 100 of FIG. 1, persons skilled in the relevant art(s) will readily appreciate that the method need not be implemented using such components.

The method of flowchart 400 begins at step 402, in which application 102 issues one or more graphics function calls that are configured to cause graphics content associated with application 102 to be displayed in an application window associated with application 102. In accordance with one implementation, application 102 comprises a video game application and the graphics content associated with application 102 comprises a 2D or 3D scene associated with the video game application.

At step 404, image capturing component 104 intercepts the graphics function call(s) issued by application 102. Various methods by which image capturing component 104 may intercept such graphics functions call(s), such as various types of API emulation and hooking, are discussed above in Section II.

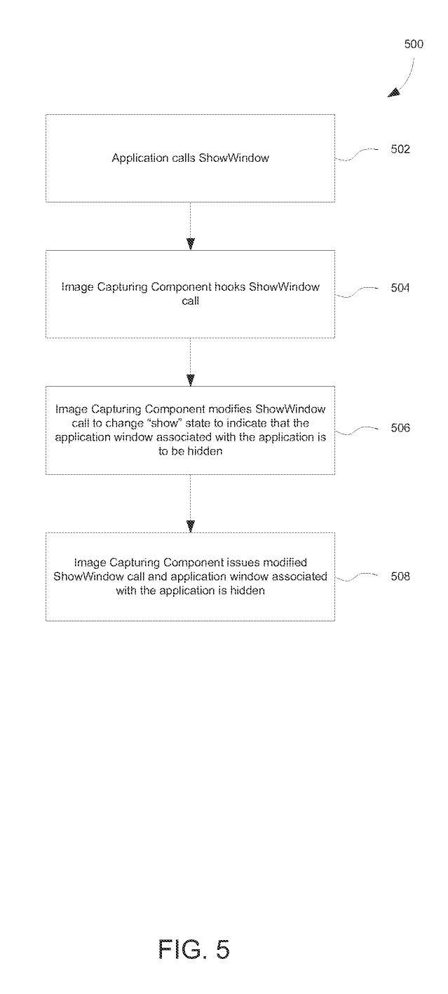

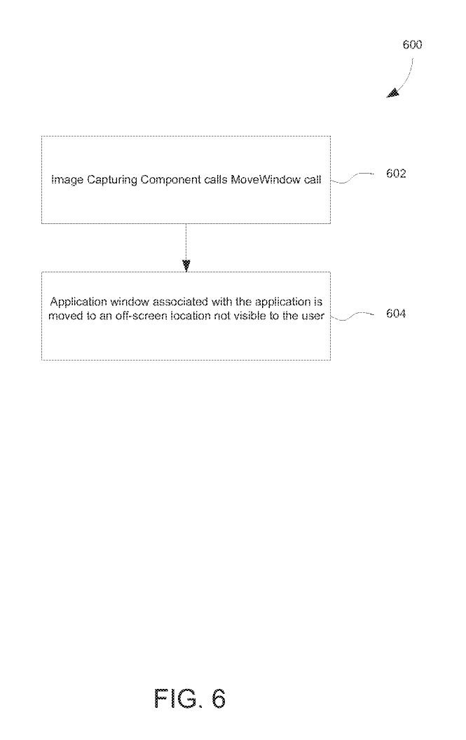

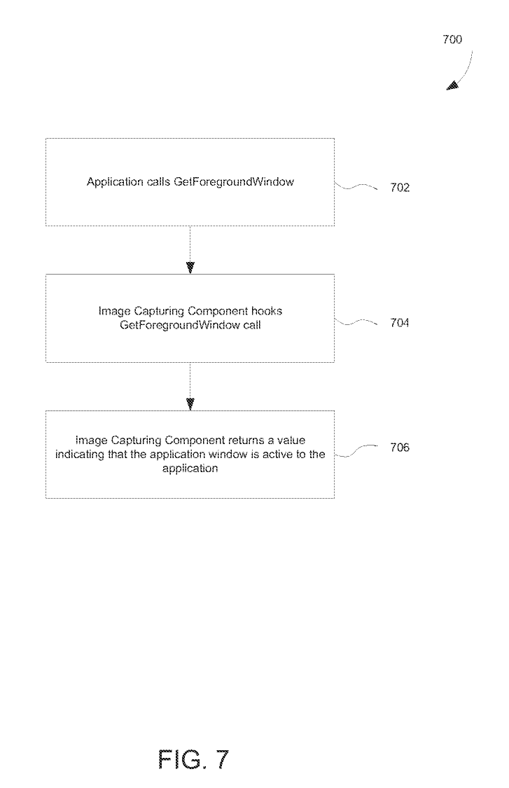

At step 406, responsive to intercepting the graphics function call(s) issued by application 202, image capturing component 104 issues one or more modified versions of the intercepted graphics function call(s) and/or one or more new function calls to hide the application window associated with application 102 and to inform application 102 that the application window associated with the application 102 is active when it is actually inactive. Further information concerning the manner in which the application window associated with application 102 is hidden will be provided herein in reference to FIGS. 5 and 6. Further information concerning the manner in which application 102 is informed that the application window associated with application 102 is active when it is actually inactive will be provided herein in reference to FIG. 7.

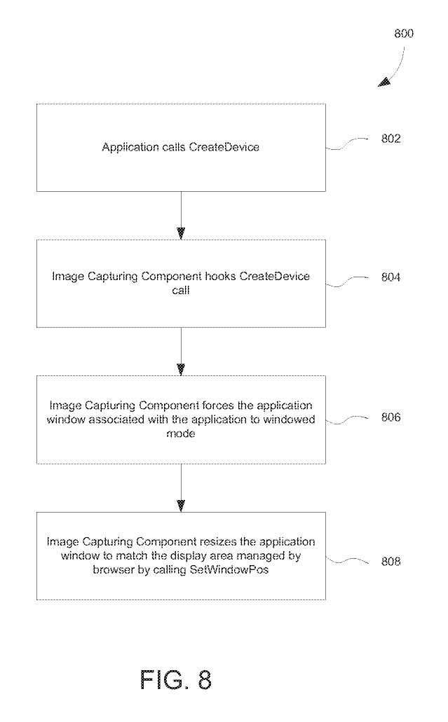

At step 408, image capturing component 104 resizes the application window to match the display area managed by the other process (e.g., browser 108). This advantageously reduces the amount of image data used for rendering a scene in the display area managed by the other process. Further information concerning the manner in which the application window associated with application 102 is resized will be provided herein in reference to FIG. 8.

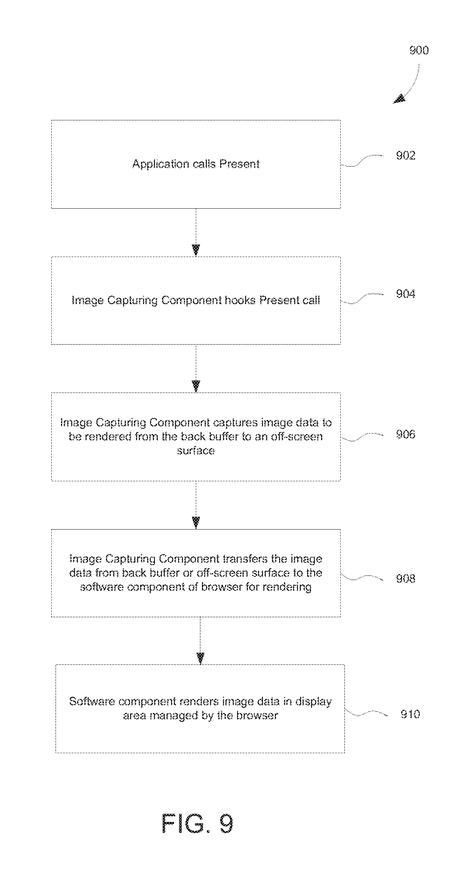

At step 410, image capturing component 104 captures the image data used for rendering a scene associated with application 102. The image data is generated by application 102 and stored in back buffer 112. In accordance with one implementation, image capturing component 104 captures the image data directly from back buffer 112. In accordance with another implementation, image capturing component 104 copies the image data from back buffer 112 to an off-screen surface 114 and captures the image data from off-screen surface 114. As previously mentioned, off-screen surface 114 may be a portion of memory exclusively used by image capturing component 104. Further information concerning the manner in which image data is captured by image capturing component 104 will be provided herein in reference to FIG. 9.

At step 412, image capturing component 104 transfers the captured image data to a software component of another process executing on computer system 100. In accordance with one implementation, the software component may be software component 110 of browser 108. In one embodiment, software component 110 may comprise an ActiveX plug-in or other plug-in, or a widget implemented using an ActiveX plug-in or other plug-in.

At step 414, software component 110 renders the image data in a display area managed by the other process (e.g., browser 108). In accordance with one implementation, the display area may be associated with a widget embedded in a Web page displayed by browser 108.

Specific methods for implementing various steps of flowchart 400 of FIG. 4 in a computer system that uses Windows APIs and/or Microsoft® Direct3D® graphics libraries will now be described with reference to FIGS. 5-9. These specific methods are presented herein by way of example only and are not intended to limit the present invention.

FIG. 5 depicts a flowchart of a method for hiding an application window that displays graphics content associated with a software application in accordance with an embodiment of the present invention. The method of flowchart 500 is described herein by way of example only and is not intended to limit the present invention. Furthermore, although the steps of flowchart 500 will described herein with reference to the components of system 100 of FIG. 1, persons skilled in the relevant art(s) will readily appreciate that the method need not be implemented using such components.

Flowchart 500 describes steps that occur when application 102 issues a Windows API ShowWindow call to specify the initial “show” state of the application window, which is intended to display graphics content associated with application 102. Generally, the “show” state for an application window indicates whether the application window is to be hidden or visible to the user. The issuance of the ShowWindow call is shown at step 502. Application 102 may initially issue the ShowWindow call having a “show” state indicating that the application window associated with application 102 is to be visible to the user. For example, in one embodiment, the application window associated with application 102 may be maximized.

At step 504, image capturing component 104 hooks the ShowWindow call. At step 506, image capturing component 104 modifies the ShowWindow call to change the “show” state to indicate that the application window associated with application 102 is to be hidden. For example, in one embodiment, the application window associated with application 102 may be minimized.

At step 508, image capturing component 104 issues the modified ShowWindow call to graphics functions 106, where it is handled in a conventional manner. The modified ShowWindow call hides the application window associated with application 102, for example, by causing the application window to be minimized.

FIG. 6 depicts a flowchart of another method for hiding an application window that displays graphics content associated with a software application in accordance with an embodiment of the present invention. The method of flowchart 600 is described herein by way of example only and is not intended to limit the present invention. Furthermore, although the steps of flowchart 600 will described herein with reference to the components of system 100 of FIG. 1, persons skilled in the relevant art(s) will readily appreciate that the method need not be implemented using such components.

Flowchart 600 describes steps that occur when image capturing component 104 issues a Windows API MoveWindow call to specify a location for the application window associated with application 102. To hide the application window associated with application 102, image capturing component 104 issues the MoveWindow call with coordinates located to an off-screen location not visible to the user. The issuance of the MoveWindow call is shown at step 602.

At step 604, upon issuance of the MoveWindow call, the application window associated with application 102 is moved to an off-screen location not visible to the user using the coordinates specified by the MoveWindow call.

FIG. 7 depicts a flowchart of a method for indicating that an application window associated with application 102 is active even though such application window is inactive in accordance with an embodiment of the present invention. In one embodiment, because the graphics content associated with application 102 is to be displayed in browser 108, the application window associated with application 102 will be inactive. However, to allow for continued execution of application 102, application 102 is informed that its application window is still active when it is actually inactive. The method of flowchart 700 is described herein by way of example only and is not intended to limit the present invention. Furthermore, although the steps of flowchart 700 will described herein with reference to the components of system 100 of FIG. 1, persons skilled in the relevant art(s) will readily appreciate that the method need not be implemented using such components.

At step 702, application 102 issues a Windows API GetForegroundWindow call to retrieve a handle to the foreground window (the active window with which a user is currently working).

At step 704, image capturing component 104 hooks the GetForegroundWindow call. At step 706, image capturing component 104 returns the handle of the minimized application window associated with application 102. However, the window that is actually in the foreground is a browser window associated with browser 108, which displays the graphics content associated with application 102.

FIG. 8 depicts a flowchart of a method for resizing the application window that displays graphics content associated with the software application in accordance with an embodiment of the present invention. In accordance with one implementation, before copying image data from either back buffer 112 or off-screen surface 114, image capturing component 104 may disable the full screen mode of the application window associated with application 102 and subsequently resize the application window to match the display area managed by browser 108. This advantageously reduces the amount of image data to be transferred to software component 110. The method of flowchart 800 is described herein by way of example only and is not intended to limit the present invention. Furthermore, although the steps of flowchart 800 will described herein with reference to the components of system 100 of FIG. 1, persons skilled in the relevant art(s) will readily appreciate that the method need not be implemented using such components.

Flowchart 800 describes steps that occur when application 102 issues a Direct3D® CreateDevice call. Application 102 issues the CreateDevice call to create a new graphics device and to specify a window in which the new graphics device should render its graphics. The issuance of the CreateDevice call is shown at step 802.

At step 804, image capturing component 104 hooks the CreateDevice call. At step 806, responsive to hooking the CreateDevice call, image capturing component 104 modifies the CreateDevice call to force the application window associated with application 102 into windowed mode. After modifying the CreateDevice call, image capturing component 104 issues the modified CreateDevice call to graphics function 106, where it is handled in a conventional manner.

At step 808, once the application window associated with application 102 is in windowed mode, image capturing component 104 resizes the application window associated with application 102 to match the display area managed by browser 108. In one embodiment, to resize the application window associated with application 102, image capturing component 104 issues a Windows API SetWindowPos call. The SetWindowPos call is configured to change the size and/or the position of the application window associated with application 102. As such, image capturing component 104 specifies the size (e.g., a width and a height) for the application window associated with application 102 when issuing the SetWindowPos call.

FIG. 9 depicts a flowchart for capturing image data generated by a software application process and transferring the image data to another process in accordance with an embodiment of the present invention. The method of flowchart 900 is described herein by way of example only and is not intended to limit the present invention. Furthermore, although the steps of flowchart 900 will described herein with reference to the components of system 100 of FIG. 1, persons skilled in the relevant art(s) will readily appreciate that the method need not be implemented using such components.

Flowchart 900 describes steps that occur when application 102 issues a Direct3D® Present call, which is issued by application 102 to render image data stored in back buffer 112 to the screen. Specifically, application 102 issues the Present call to render the image data to a display area managed by the application window associated with application 102. The issuance of the Present call is shown at step 902.

At step 904, image capturing component 104 hooks Present call. At step 906, responsive to hooking the Present call, image capturing component 104 captures the image data to be rendered. In one embodiment, image capturing component 104 captures the image data directly from back buffer 112. In another embodiment, image capturing component 104 copies the image data from back buffer 112 to off-screen surface 114 and captures the image data from off-screen surface. As previously mentioned, off-screen surface 114 is a portion of memory exclusively used by image capturing component 104.

To improve performance, image capturing component 104 may not hook every Present call issued by application 104. For example, in one embodiment, image capturing component 104 may hook every other Present call. In another embodiment, image capturing component 104 may dynamically adjust the number of Present calls hooked based on the performance of computer system 100 executing application 102, image capturing component 104, and browser 108. In this case, image capturing component 104 may hook a lesser amount of Present calls for slower performing computer systems as compared to higher performing computer systems.

At step 908, image capturing component 104 transfers the captured image data to software component 110 of browser 108 for rendering.

At step 910, software component 110 renders the image data to a display area managed by browser 108. For example, in one embodiment, software component 110 may be a widget implemented using an ActiveX plug-in or other plug-in. As such, the display area may be associated with a widget embedded in a Web site displayed by browser 108.

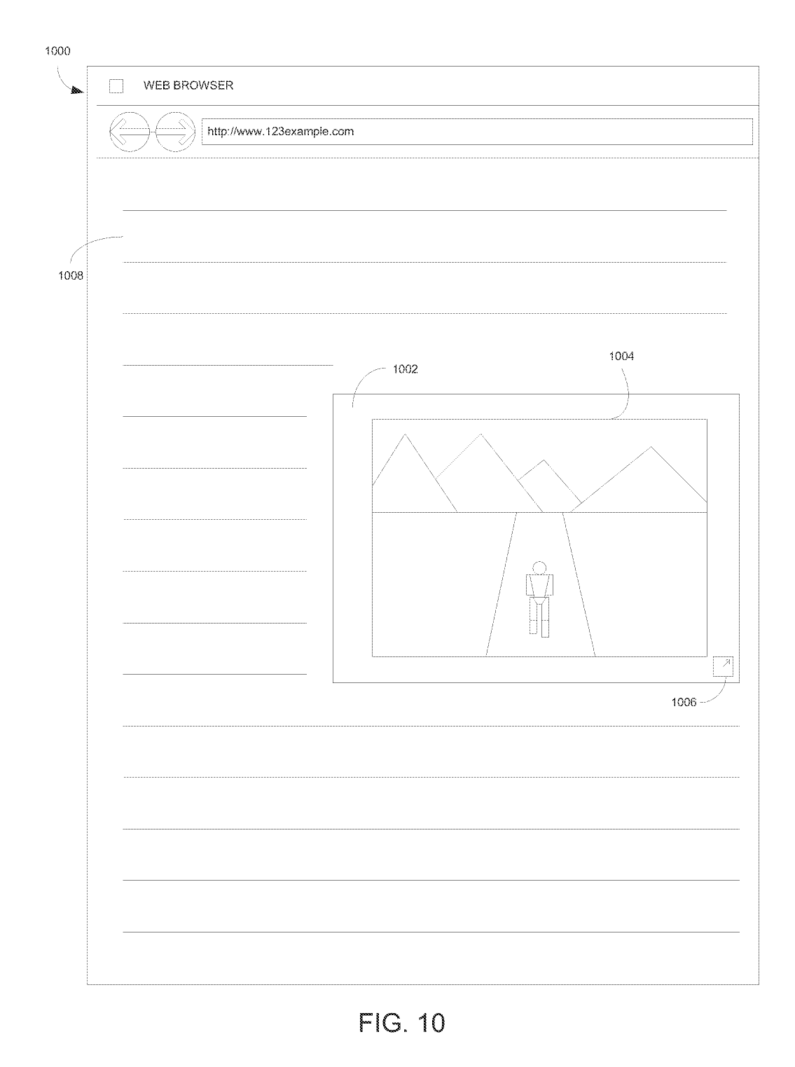

FIG. 10 depicts an example browser window 1000 to which graphics content has been displayed in a display area managed by browser window 1000 in accordance with the method of flowcharts 400, 500, 600, 700, 800 and 900. As shown, browser window 1000 also includes a widget 1002 embedded in a Web site 1008 viewable in browser window 1000. Widget 1002 includes a widget display area 1004 for displaying graphics content associated with another process, such as application 102.

As shown in FIG. 10, the application-related scene is rendered to widget display area 1004. The rendering of the application-related scene occurs in response to the hooking of a Present call issued by application 102 as described above in reference to flowchart 900 of FIG. 9. The application-related scene rendered to widget display area 1004 may comprise a scene associated with a video game application. As shown, the application-related scene has also been resized from a full-screen to smaller windowed screen to fit in widget display area 1004 as described above in reference to flowchart 800 of FIG. 8.

As further shown in FIG. 10, widget 1002 also includes screen resize control 1006. Screen resize control 1006 is configured to stretch widget display area 1004 to an overlaid full-screen mode upon activation from a user. In one embodiment, in response to activating screen resize control 1006, widget display area 1004 may be stretched to an overlaid full-screen mode by stretching the HTML inline frame (IFrame), which contains widget 1002, to cover all or most of browser window 1000. In another embodiment, in response to activating screen resize control 1006, the HTML IFrame containing widget 1002 may be opened in a new browser window that overlaps browser window 1000. In this new browser window, widget display area 1004 may be stretched to cover all or most of the new browser window.

### IV. Dynamic Pointer Image Repositioning in Accordance with an Embodiment of the Present Invention

As described above, an embodiment of the present invention displays graphics content associated with a software application process, such as a video game application process, to a display area managed be another process, such as a browser. The display area managed by the browser may be much smaller than a display area associated with the video game application. For example, the display area associated with the video game application may be a full-screen display area (or a large windowed display area), whereas the display area managed by the browser is a smaller windowed display area. Consequently, the graphics content is resized before being displayed in the display area managed by the browser. This is done in order to allow a user to interact with both the application now displayed in the browser and any additional content viewable by the browser.

When such a technique is applied to a software application that allows a user to interact with objects within the display area using a pointer device (e.g., a mouse, keyboard, or any other I/O device capable of controlling a pointer), special care must be taken to ensure that the pointer image is displayed in the appropriate position and that the application receives pointer coordinates back from I/O elements in a position that will allow regular control of the application by the user. In particular, special care must be taken to ensure that the pointer image is displayed in an appropriate position within the resized application scene as opposed to the position at which the pointer image would normally have been displayed prior to resizing.

For applications that render the pointer image along with all the other objects rendered within a scene, the position of the pointer image is automatically adjusted when a scene rendered by the application is resized in accordance with one of the foregoing methods. However, when the display of the pointer image is managed by an entity outside of the application, such as by an operating system, a separate method must be used to reposition the pointer image to adjust for the resizing of the application scene. Such a method will now be described.

The method of flowchart 1100 begins at step 1102, in which a pointer event occurs. The pointer event may comprise, for example, a function call issued by an operating system within computer system 100. The function call may be issued responsive to the receipt of input from a pointing device within or attached to computer system 100.

At step 1104, software component 110 captures the pointer event. To this end, software component 110 may include a low-level pointer hook. Where the operating system is a Microsoft® Windows® operating system, the pointer hook may be set using a function such as SetWindowsHookEx. However, this approach is described by way of example only, and is not intended to be limiting. Many other techniques well-known to persons skilled in the relevant art(s) may be used to capture the pointer event.

Responsive to the capture of the pointer event, software component 110 performs several functions. In particular, at step 1106, software component 110 saves the current position of the pointer image as determined by the operating system. At decision step 1108, software component 110 determines if the pointer image maintained by the operating system is new or has changed as a result of the pointer event. If the pointer image is not new and has not changed as a result of the pointer event, then processing proceeds to step 1112. However, if the pointer image is new or has changed as a result of the pointer event, then software component 110 converts the pointer image to a bitmap or texture and saves it as shown at step 1110. This may be achieved in a Microsoft® Windows® environment, for example, by capturing a mouse cursor using an HCURSOR handle and obtaining an associated bitmap from the device context (DC) of the system. Processing then proceeds to step 1112, during which software component 110 disables the normal display of the pointer image by the operating system.

At step 1114, image capturing component 104 uses the current position of the pointer image that was saved by software component 110 to calculate a new position for the pointer image within the resized application-related scene. At step 1116, image capturing component 104 then draws the bitmap or texture representation of the pointer image saved by software component 110 to the new position within the resized application-related scene. Steps 1114 and 1116 may be performed by image capturing component 104 responsive to intercepting a Present call from application 102.

In one embodiment of the present invention, software component 110 is configured to perform steps 1106 through 1112 as described above only when it is determined that the captured pointer event is a pointer movement event.

The result of the foregoing method is that the display of a pointer image associated with application 102 is bounded with the resized area defined by graphics image capturing component 104 for displaying an application-related scene.

### V. Example Computer System Implementation

FIG. 12 depicts an exemplary computer system 1200 that may be used to implement computer system 100 of FIG. 1. Computer system 1200 may comprise a general-purpose computing device, such as a conventional personal computer, an interactive entertainment computer or electronic device, such as a video game console, a cellular phone, personal digital assistant, or any other device that is capable of executing software applications and displaying associated application-generated graphics information to an end-user. Computer system 1200 is configured to perform the functions of computer system 100 of FIG. 1 as described elsewhere herein.

As shown in FIG. 12, example computer system 1200 includes a processor 1204 for executing software routines. Although a single processor is shown for the sake of clarity, computer system 1200 may also comprise a multi-processor system. Processor 1204 is connected to a communication infrastructure 1202 for communication with other components of computer system 1200. Communication infrastructure 1202 may comprise, for example, a communications bus, cross-bar, or network.

Computer system 1200 further includes a main memory 1206, such as a random access memory (RAM), and a secondary memory 1212. Secondary memory 1212 may include, for example, a hard disk drive 1222 and/or a removable storage drive 1224, which may comprise a floppy disk drive, a magnetic tape drive, an optical disk drive, or the like. Removable storage drive 1224 reads from and/or writes to a removable storage unit 1250 in a well-known manner. Removable storage unit 1250 may comprise a floppy disk, magnetic tape, optical disk, or the like, which is read by and written to by removable storage drive 1224. As will be appreciated by persons skilled in the relevant art(s), removable storage unit 1250 includes a computer usable storage medium having stored therein computer software and/or data.

In an alternative implementation, secondary memory 1212 may include other similar means for allowing computer programs or other instructions to be loaded into computer system 1200. Such means can include, for example, a removable storage unit 1260 and an interface 1226. Examples of a removable storage unit 1260 and interface 1226 include a program cartridge and cartridge interface (such as that found in video game console devices), a removable memory chip (such as an EPROM or PROM) and associated socket, and other removable storage units 1260 and interfaces 1226 which allow software and data to be transferred from the removable storage unit 1260 to computer system 1200.

Computer system 1200 also includes at least one communication interface 1214. Communication interface 1214 allows software and data to be transferred between computer system 1200 and external devices via a communication path 1270. In particular, communication interface 1214 permits data to be transferred between computer system 1200 and a data communication network, such as a public data or private data communication network. Examples of communication interface 1214 can include a modem, a network interface (such as Ethernet card), a communication port, and the like. Software and data transferred via communication interface 1214 are in the form of signals which can be electronic, electromagnetic, optical or other signals capable of being received by communication interface 1214. These signals are provided to the communication interface via communication path 1270.

As shown in FIG. 12, computer system 1200 further includes a display interface 1208, which performs operations for rendering images to an associated display 1230 and an audio interface 1210 for performing operations for playing audio content via associated speaker(s) 1240.

As used herein, the term “computer program product” may refer, in part, to removable storage unit 1250, removable storage unit 1260, a hard disk installed in hard disk drive 1222, or a carrier wave carrying software over communication path 1270 (wireless link or cable) to communication interface 1214. A computer useable medium can include magnetic media, optical media, or other recordable media, or media that transmits a carrier wave or other signal. These computer program products are means for providing software to computer system 1200.

Computer programs (also called computer control logic) are stored in main memory 1206 and/or secondary memory 1212. Computer programs can also be received via communication interface 1214. Such computer programs, when executed, enable the computer system 1200 to perform one or more features of the present invention as discussed herein. In particular, the computer programs, when executed, enable the processor 1204 to perform features of the present invention. Accordingly, such computer programs represent controllers of the computer system 1200.

Software for implementing the present invention may be stored in a computer program product and loaded into computer system 1200 using removable storage drive 1224, hard disk drive 1222, or interface 1226. Alternatively, the computer program product may be downloaded to computer system 1200 over communications path 1270. The software, when executed by the processor 1204, causes the processor 1204 to perform functions of the invention as described herein.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for rendering graphics content associated with a software application process executing on a computing device in a display area managed by another process executing on the computing device, comprising:
intercepting one or more function calls issued from the software application process executing on the computing device;
capturing an image stored in a first portion of memory in response to intercepting the one or more function calls; and
rendering the captured image in the display area managed by the other process.

2. The method of claim 1, wherein the other process is a web browser.

3. The method of claim 1, wherein intercepting one or more function calls comprises at least one of:
intercepting a first function call configured to show an application window associated with the software application;
intercepting a second function call configured to show the application window in a full screen mode.
issuing a third function call configured to hide the application window associated with the software application in response to intercepting the first function call;
issuing a fourth function call configured to disable the full screen mode in response to intercepting the second function call; and
issuing a fifth function call configured to resize the application window to match the display area managed by the other process.

4. The method of claim 1, wherein capturing an image stored in a first portion of memory in response to intercepting the one or more function calls comprises:
copying the image from the first portion of the memory to a second portion of the memory; and
transferring the image from the second portion of the memory to the other process for display.

5. The method of claim 3, wherein the third function call is configured to move the application window to an off-screen location.

6. The method of claim 3, wherein the third function call is configured to minimize the application window.

7. The method of claim 1, where in the first portion of memory is a back buffer.

8. A computer program product comprising a computer-readable storage medium having computer program logic recorded thereon for enabling a processing unit to display graphics content associated with a software application process executing on a computing device in a display area managed by another process executing on the computing device, wherein the computer program logic comprises:
first means for enabling the processing unit to intercept one or more function calls issued from the software application process executing on the computing device;
second means for enabling the processing unit to capture an image stored in a first portion of memory in response to intercepting the one or more function calls; and
third means for enabling the processing unit to display the captured image in the display area managed by the other process.

9. The computer program product of claim 8, wherein the other process is a web browser.

10. The computer program product of claim 8, wherein the first means comprises at least one of:
fourth means for enabling the processing unit to intercept a first function call configured to show an application window associated with the software application;
fifth means for enabling the processing unit to intercept a second function call configured to show the application window in a full screen mode.
sixth means for enabling the processing unit to issue a third function call configured to hide the application window associated with the software application in response to intercepting the first function call;
seventh means for enabling the processing unit to issue a fourth function call configured to disable the full screen mode in response to intercepting the second function call; and
eighth means for enabling the processing unit to issue a fifth function call configured to resize the application window to match the display area managed by the other process.

11. The computer program product of claim 8, wherein the second means comprises:
fourth means for enabling the processing unit to copy the image from the first portion of the memory to a second portion of the memory; and
fifth means for enabling the processing unit to transfer the image from the second portion of the memory to the other process for display.

12. The computer program product of claim 10, wherein the third function call is configured to move the application window to an off-screen location.

13. The computer program product of claim 10, wherein the third function call is configured to minimize the application window.

14. The computer program product of claim 8, where in the first portion of the memory is a back buffer.

15. A system, comprising:
a processing unit; and
a memory containing instructions, which, when executed by the processing unit, causes graphics content associated with a software application process being executed by the processing unit to be displayed within a display area managed by another process being executed by the processing unit by performing the steps of:
intercepting one or more function calls issued from the software application process;
capturing an image stored in a first portion of memory in response to intercepting the one or more function calls; and
displaying the captured image in the display area managed by the other process.

16. The system of claim 15, wherein the other process is a web browser.

17. The system of claim 15, wherein intercepting one or more function calls issued from the software application process comprises at least one of:
intercepting a first function call configured to show an application window associated with the software application;
intercepting a second function call configured to show the application window in a full screen mode.
issuing a third function call configured to hide the application window associated with the software application in response to intercepting the first function call;
issuing a fourth function call configured to disable the full screen mode in response to intercepting the second function call; and
issuing a fifth function call configured to resize the application window to match the display area managed by the other process.

18. The system of claim 15, wherein capturing an image stored in a first portion of memory in response to intercepting the one or more function calls comprises:
copying the image from the first portion of the memory to a second portion of the memory; and
transferring the image from the second portion of the memory to the other process for display.

19. The system of claim 17, wherein the third function call is configured to move the application window to an off-screen location.

20. The system of claim 15, wherein the first portion of the memory is a back buffer.
